(19) United States
(12) Patent Application Publication
(10) Pub. No.: US 2006/0266227 A1
(43) Pub. Date: Nov. 30, 2006

(54) Cooking device

(76) Inventors: Gary Earl Britt, Berlin, MD (US); David Wilbur Nickson, Belgrade, MT (US)

Correspondence Address: FISH & RICHARDSON P.C., PO BOX 1022, MINNEAPOLIS, MN, 55440-1022, US

(21) Appl. No.: 11/137,065

(22) Filed: May 25, 2005

(51) Int. Cl. A47J 43/18

(52) U.S. Cl. 99/426

(57) ABSTRACT

Some embodiments of a cooking device may be configured to support a food product (e.g., a poultry item) in an elevated position above a cooking surface (e.g., the bottom of a roasting pan) such that a breast portion of the poultry item faces substantially downward. In such embodiments, the poultry item may be roasted while the juices serve to moisten the breast portion of the poultry item. Also in such embodiments, the poultry item may be elevated above the cooking surface while being supported by the cooking device from the inside, which can reduce the likelihood of localized burns on the contacted skin of the poultry item.

### TECHNICAL FIELD

This document relates to devices and methods for cooking food products.

### BACKGROUND

Ovens and other cooking systems often employ heated airflow to cook food products. One or more devices may be used during the cooking process to prepare the food product in a desired manner. For example, a roasting pan may be used to cook a poultry item by placing the poultry item on a bottom surface of the pan and then roasting the poultry item in an oven chamber for a predetermined period of time. In another example, a rotatable spit may be used to roast a pig or lamb over an open fire or heated coals.

The design of such cooking devices may be affected my a number of factors, such as the desired position of the food product during the cooking process. For example, if a poultry item is to be maintained in a vertically upright position, the cooking device may include a vertically upright stem that engages and secures the poultry item's position. In such circumstances, the juices from the poultry item may be drained out of the cavity opening at the rear end of the poultry item, which can cause over-drying of some meat portions of the poultry item. In another example, if a poultry item is to be maintained in a substantially horizontal position (e.g., resting on a roasting pan with the breast portion facing upward), the cooking device may include a horizontal surface (e.g., the bottom of a pan) upon which the backside of the poultry item rests. In such cases, the backside of the poultry item that is in contact with the bottom of the pan may become blackened compared to other parts of the poultry item. Also in these cases, the juices from the upward-facing breast portion may drain downward, thereby causing the breast portions to become over-dried.

Another factor that may affect the design of cooking devices is the type of cooking environments in which the food product is cooked. For example, a pan may include a bottom surface that is sized to receive a poultry item thereon so that the pan may be used to apply contact heat to the poultry item. If the pan also includes vertical sidewalls, juices or other liquids may gather on the bottom surface such that a portion of the poultry item is boiled in the juices. In such circumstances, the poultry item may be exposed to multiple cooking environments, for example, a contact-heat environment and a boiling-liquid environment. Exposure to multiple cooking environments may cause uneven cooking among various portions of the poultry item.

### SUMMARY

Some embodiments of a cooking device may be configured to support a food product (e.g., a poultry item) in an elevated position above a cooking surface (e.g., the bottom of a roasting pan) such that a breast portion of the poultry item faces substantially downward. In such embodiments, the poultry item may be roasted while the juices serve to moisten the breast portion of the poultry item. Also in such embodiments, the poultry item may be elevated above the cooking surface while being supported by the cooking device from the inside, which can reduce the likelihood of localized burns or blackening on exterior of the poultry item.

In some embodiments, a cooking device may include at least one base member to rest upon a cooking surface. The cooking surface may extend in a substantially horizontal direction. The cooking device may also include a rack to retain a poultry item. The rack may coupled to the base member and may have at least one upper support member to engage an internal portion of the poultry item. At least a portion of the upper support member extending in an inclined direction that is angled relative to the substantially horizontal direction when the base member rests upon the cooking surface. In such embodiments, when the rack retains the poultry item, the rack may be operable to maintain the poultry item in an elevated position above the cooking surface such that a breast portion of the poultry item faces substantially downward toward the cooking surface.

In some embodiments, a cooking device may include a base means for resting upon a cooking surface that extends in a substantially horizontal direction. The cooking device may also include a means for retaining a poultry item in an elevated position above the cooking surface such that a breast portion of the poultry item faces substantially downward toward the cooking surface. The retaining means may be coupled to the base means and may be operable to extend into an internal cavity of the poultry item.

In some embodiments, a method of cooking a poultry item includes inserting at least a portion of a rack device inside an internal cavity of a poultry item. The method may also include arranging at least a portion of the rack device on a cooking surface such that the rack device supports the poultry item in an elevated position above the cooking surface. The method may further include heating the poultry item for a period of time while a breast portion of the poultry item continuously faces substantially downward toward the cooking surface.

These and other embodiments may be configured to provide one or more of the following advantages. First, the device may be used to cook poultry items in a position with the breast portion facing generally downward. Such a configuration may provide a more desirable and moist meat product because juices in the poultry item's cavity can penetrate into the breast portions rather than draining out of the poultry item's rear cavity opening. Second, the device may be used to engage the poultry item from the inside. In such circumstances, the poultry item may be cooked without scarring from contact heat and without sticking to roasting pans, dishes, or racks. Third, the device may be used to elevate the poultry item above the cooking surface, such as the bottom of a pan or barbeque rack. When the poultry item is in such a position, it may be cooked in a more uniform manner by avoiding localized contact heat (e.g., from touching a metal pan) and partial boiling (e.g., only a portion of the item is disposed in boiling fluids). Also, when the poultry item is cooked in the elevated position, it may avoid sitting in its own liquid fatty mixtures, which may provide a healthy meat product by reducing the likelihood of reabsorbing fatty compositions. Fourth, in some embodiments in which the device is used with a roasting pan, the poultry item may be elevated above the bottom of the roasting pan while the poultry item's breast portion is positioned at or below the height of the roasting pan sidewalls. In these circumstances, the breast portion may be less exposed to circulating dry air in a oven or other cooking environment, thereby permitting the breast portion to be cooked in a more uniform manner without over-drying the breast meat. Fifth, the device may be constructed from food-safe and dishwasher-safe material, such as stainless steel. In such embodiments, the device may be readily cleaned and stored be a user. Some or all of these and other advantages may be provided by the devices described herein.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a cooking device, in accordance with some embodiments.

FIG. 2 is a side view of the device of FIG. 1.

FIG. 3 is another perspective view of the device of FIG. 1.

FIG. 4 is a top view of the device of FIG. 1.

FIG. 5A is perspective view of one embodiment of a cooking device.

FIG. 5B is a perspective embodiment of another embodiment of a cooking device.

FIG. 5C is a perspective view of yet another embodiment of a cooking device.

FIG. 6A is a side view of the device of FIG. 5A.

FIG. 6B is a side view of the device of FIG. 5B.

FIG. 6C is a side view of the device of FIG. 5C.

FIG. 7A is a top view of the device of FIG. 5A.

FIG. 7B is a top view of the device of FIG. 5B.

FIG. 7C is a top view of the device of FIG. 5C.

FIG. 8 is a view of an article that can be form into a cooking device, in accordance with certain embodiments.

Like reference symbols in the various drawings indicate like elements.

### DETAILED DESCRIPTION OF ILLUSTRATIVE EMBODIMENTS

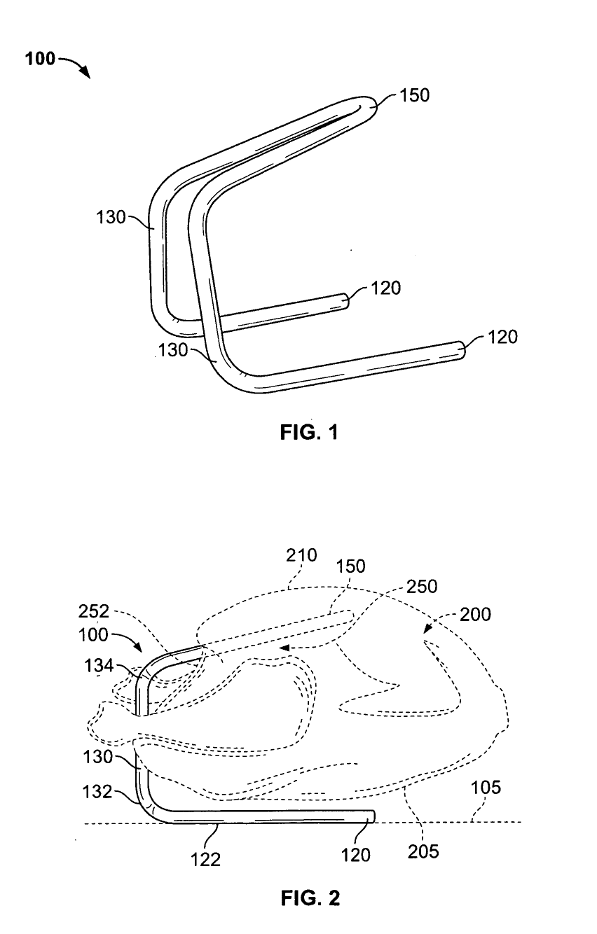

Referring to FIG. 1, a cooking device 100 may include one or more base members 120 and at least one rack portion 150. The cooking device 100 may be configured to engage a food product, such as a poultry item, so that the food product is elevated above a cooking surface. In some embodiments, the cooking device 100 may be capable of maintaining a food product in a position such that liquids are not necessarily drained from the product's cavity opening. For example, the cooking device 100 may be configured to engage a poultry item in an elevated position above a cooking surface such that the breast portion of the poultry item faces generally downward toward the cooking surface. In such circumstances, juices in the poultry item's internal cavity may be directed into the breast portions so that the breast portions remain moist throughout the cooking process.

In some embodiments, the base members 120 and the rack portion 150 may be integrally formed such that the rack portion 150 is maintained in a substantially fixed position relative to the base members 120. For example, an elevation member 130 may be used to couple the rack portion 150 to a base member 120. The elevation member 130 may be configured to arrange the rack portion 150 at a predetermined height above the base members 120. The elevation member may be a substantially rigid structure that is integrally formed with the rack portion 150 and the base member 120. In this embodiment, each of the base members 120 extends in a substantially horizontal direction and the associated elevation member 130 extends and a substantially vertical direction. As described in more detail below, the rack portion 150 may extend from the elevation members 130 in a substantially non-horizontal direction so that the rack portion 150 is inclined relative to the base members 120.

Referring now to FIG. 2, the cooking device 100 may be used to maintain a poultry item 200, such as chicken, duck, turkey, or the like, in an elevated position above a cooking surface 105. In this example, the poultry item 200 is a chicken that has been prepared for roasting. The base members 120 may rest upon the cooking surface 105 so that the rack portion 150 is elevated above the cooking surface 105. In some embodiments, the cooking surface 105 may be, for example, a roasting pan, a cooking tray, a casserole dish, a barbecue rack, or the like. At least a portion of the base members 120 may extend in the substantially horizontal direction on the cooking surface 105. As shown in FIG. 2, a base surface 122 of each base member 120 is configured to abut the cooking surface 105. While the base members 120 rest upon the cooking surface 105, the rack portion 150 may retain the poultry item 200 in the elevated position. Accordingly, the poultry item 200 may avoid direct-contact heat transfer from the cooking surface 105. In such embodiments, the cooking device 100 may reduce the likelihood of scarring or blackening the poultry item during the cooking process because localized contact heat (e.g., from touching a metal pan) may be avoided.

The rack portion 150 of the cooking device 100 may be configured to engage an interior portion of the poultry item 200. When the rack portion 150 engages the poultry item 200 from the inside, the poultry item 200 may be roasted without receiving scars or blackened marks from localized contact heat with the cooking device 100. In this embodiment, a lower end 132 of each elevation member 130 is joined with an associated base member 120 such that the elevation member 130 extends generally upward from the base member 120. The rack portion 150 may extend from an upper end 134 of the elevation member 130 in a slightly inclined direction. The rack portion 150 may be sized to fit inside and internal cavity 250 having an opening 252 proximal the rear end of the poultry item 200. When the rack portion 150 is inserted into the internal cavity 250 and engages the interior portion of the poultry item 200, the poultry item 200 may be maintained in an elevated position above the cooking surface 105 such that a breast portion 205 of the poultry item faces substantially downward toward the cooking surface 105.

Still referring to FIG. 2, the cooking device 100 is capable of maintaining the poultry item 200 in the elevated position with the breast portion 205 facing substantially downward throughout the entire cooking process. For example, the cooking device 100 may be used during a roasting process such that juices or other liquids in the internal cavity 250 of the poultry item 200 may be directed generally downward toward the breast portion 205. As such, the breast portion 205, which can be one of the more desirable meat portions of the poultry item 200, is substantially moistened throughout the roasting process, thereby avoiding over-dried breast meat. Thus, the cooking device 100 may provide a more desirable and moist meat product because the juices from the poultry item's back portions 210 can penetrate into the breast portions 205 rather than draining out of the cavity opening 252 at the rear end of the poultry item 200.

In the embodiment depicted in FIG. 2, the breast portion 205 may face generally downward continuously through the cooking process. In such circumstances, the breast portion 205 may be continually moistened from juices in the internal cavity 250 of the poultry item 200. If the poultry item was rotated during the cooking process such that the breast portion 205 periodically faces upward, some portion of the juices may not fully penetrate the breast portion 205 or may drain out of the cavity opening 252 proximal the rear end of the poultry item.

As shown in FIG. 2, the rack portion 150 may extend in an inclined direction relative to the substantially horizontal base member 120. The angle of inclined of the rack portion 150 may very depending on the type of poultry item 200 with which the rack portion 150 is to be engaged. For example, if the rack portion 150 extends at too great of an incline, the poultry item 200 may be maintained in a substantially upright position such that juices in the internal cavity 250 drain out of the cavity opening 252. In some cases, if the rack portion extends in a generally declined direction, the poultry item 200 may unintentionally disengage from the rack portion 150 before, during, or after the cooking process. Accordingly, the rack portion 150 may extend in a generally inclined direction so that the breast portion 205 is maintained at a position lower than the cavity opening 252 so that the poultry item 200 is substantially retained by the rack portion 150.

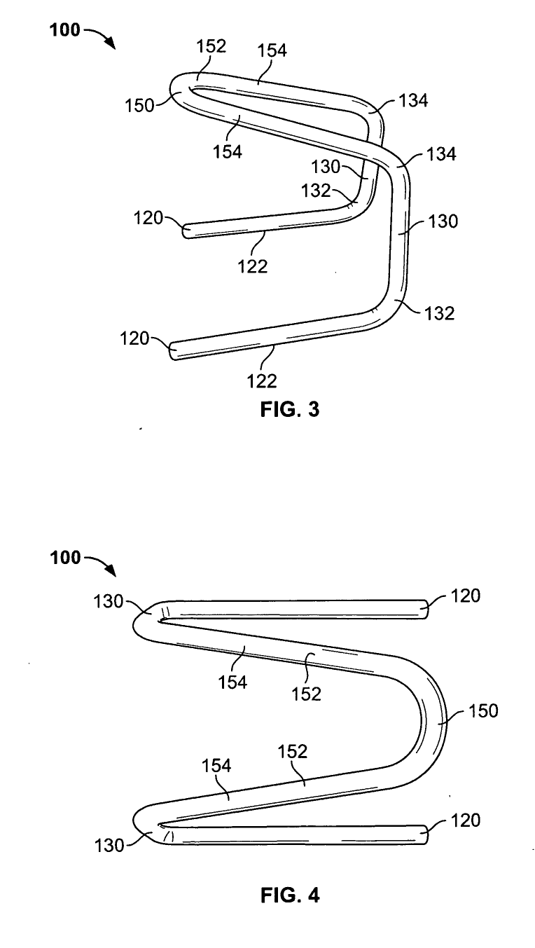

Referring now to FIGS. 3-4, the base members 120 of the cooking device 100 may be arranged to provide sufficient balance and support when the rack portion 150 is engaged with the poultry item 200. In this embodiment, the rack portion 150 includes a substantially U-shaped structure that extends from the elevation members 130. The base members 120 are positioned generally outward of the rack portion 150 (refer to FIG. 4) so that the cooking device 100 is not readily tipped over when the poultry item 200 is engaged with the rack portion 150.

The upper surface 152 of the rack portion 150 may be shaped to contact an interior portion of the poultry item 200, such as tissue proximal to the backbone of the poultry item 200. In this embodiment, the top surface 152 has a substantially U-shaped configuration in which at least a portion of the poultry item's backbone a be disposed between a pair of elongate rack members 154. In other embodiments, the upper surface 152 may comprise a substantially planar tongue that engages the tissue proximal to the backbone.

It should be understood that the cooking device 100 is not limited to the embodiments illustrated herein. For example, a base member may comprise a substantially planar disc or footing that is configured to rest on a substantially horizontal cooking surface 105. Alternatively, a base member 120 may be curved to form an arcuate or circular rod that is capable of resting on a substantially horizontal cooking surface 105. Furthermore, the rack portion 150 may have various shapes and configurations that are adapted to engage and interior portion of a poultry item 200 or other food product. For example, the rack portion 150 may include only one substantially planar tongue member that extends from the elevation members 130. In another example, the rack portion may comprise two, three, four, five, six, or more extension fingers that extend from the elevation members 130 and are configured to extend into the cavity 250 and to engage an interior portion of the poultry item 200.

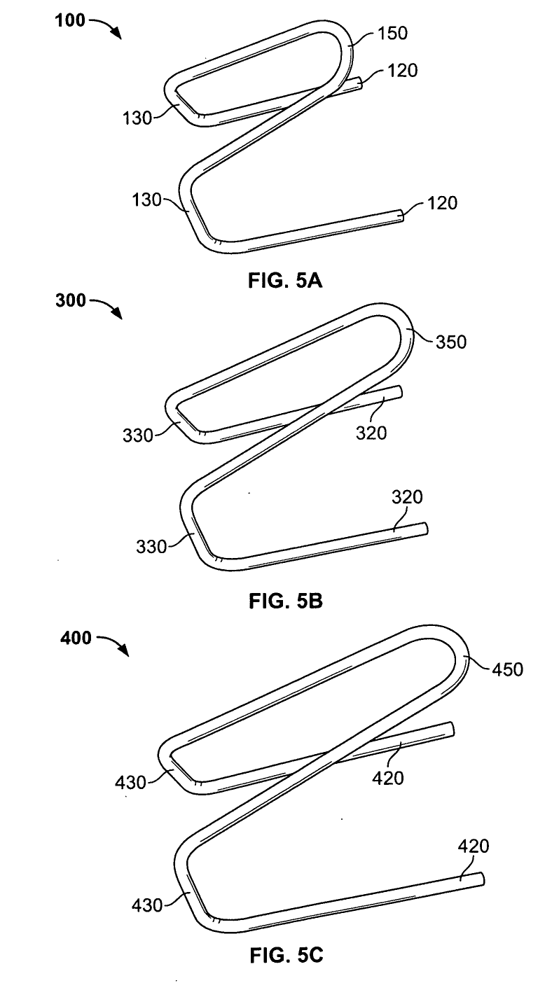

Referring now to FIGS. 5A-C, the cooking device may be configured to retain food products of varying sizes and shapes. As shown in FIG. 5A, the cooking device 100 comprises the previously described base members 120, elevation members 130, and rack portion 150. Such a device 100 may be configured to receive a poultry item 200, such as a chicken that has been prepared for roasting. As shown in FIG. 5B, another embodiment of a cooking device 300 may include base members 320 that are larger than the previously described base members 120. The base members 320 may be configured to support a larger rack portion 350, which in turn is configured to support a larger-sized poultry item. For example, the rack portion 350 may be sized to fit inside an interior cavity of a duck that has been prepared for roasting. In such circumstances, the duck may have a substantially larger interior cavity than that of the previously described chicken. Accordingly, the rack portion 350 of the cooking device 300 in FIG. 5B may extend for a greater length then the rack portion 150 of the cooking device 100 in FIG. 5A. As shown in FIG. 5C, yet another embodiment of a cooking device 400 includes base members 420 that are larger than the base members 120 and 320 of FIGS. 5A-B, respectively. The base members 420 may be configured to support a poultry item that is larger than the previously described duck and the previously described chicken. For example, the rack portion 450 may be sized to fit inside an interior cavity of a turkey that has been prepared for roasting. In this case, the turkey may have an interior cavity that is larger than both the previously described duck and the previously described chicken, in which case the rack portion 450 may extend for a greater length than the rack portions 150 and 350 shown in FIGS. 5A-B, respectively. Thus, the cooking devices 100, 300, and 400 may be configured to retain food products of various shapes and sizes, such as chickens, ducks, turkeys, or the like.

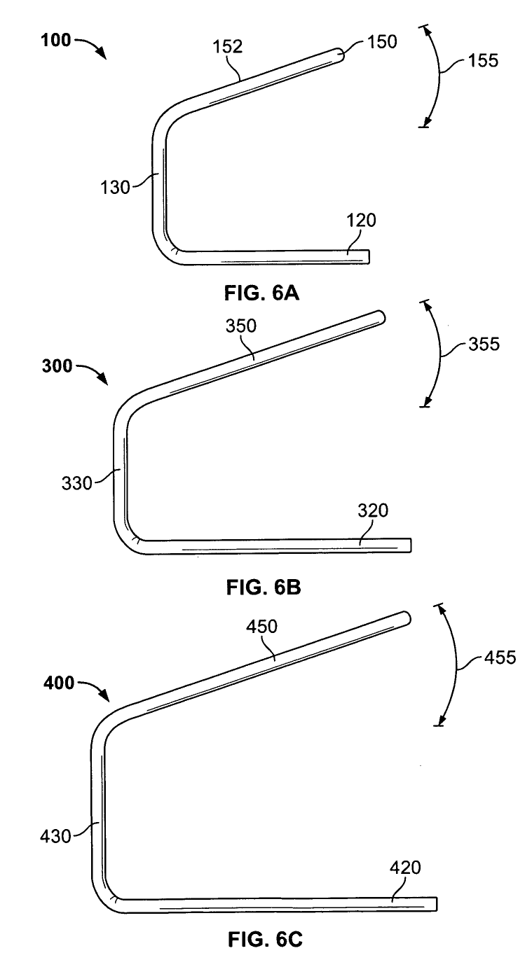

Referring now to FIGS. 6A-C, the relative sizes of the rack portions 150, 350, and 450 are shown in more detail. Also, the relative sizes of the base members 120, 320, and for 20 are shown in FIGS. 6A-C. As previously described the rack portion 450 of the cooking device 400 (FIG. 6C) may extend for a greater length than the rack portion 350 of the cooking device 300 (FIG. 6B), which in turn may extend for a greater length than the rack portion 150 of the cooking device 100 (FIG. 5A). The sizes and configurations of the rack portions 150, 300, and 450 may vary depending upon the type of food product to which the rack portion will be engaged.

As previously described, each rack portion 150, 350, or 450 may extend in an inclined direction relative to the substantially horizontal base member 120, 320, or 420, respectively. The angle of inclined of the rack portion may very depending on the type of poultry item (e.g., chicken, duck, turkey, or the like) with which the rack portion is to be engaged. For example, if the rack portion 150 (FIG. 6A) extends at too steep of an incline, the poultry item may be maintained in a substantially upright position such that juices in the internal cavity can drain out of the cavity opening proximal the rear end of the poultry item. Alternatively, if the rack portion extends in a generally declined direction, the poultry item may unintentionally disengage (e.g., slide off) from the rack portion before, during, or after the cooking process. Accordingly, the rack portion may extend in a generally inclined direction so that the poultry item's breast portion is maintained at a position lower then the cavity opening and so that the poultry item is substantially retained by the rack portion.

Still referring to FIGS. 6A-C, the rack portion may extend in an inclined direction at an angle 155, 355, and 455 relative to the substantially horizontal direction of the base members. The inclined angle 155, 355, or 455 of the rack portion may be less than approximately 35°, depending upon the size and configuration of the poultry item to which the rack portion is to be engaged. As shown in FIG. 6A, the rack portion 150 extends an inclined direction at an angle 155 of about 5° to about 35°, preferably about 10° to about 20°, and in some embodiments about 17.5°. As shown in FIG. 6B, the rack portion 350 extends an inclined direction at an angle 355 of about 5° to about 35°, preferably about 10° to about 20°, and in some embodiments about 18.5°. As shown in FIG. 6C, the rack portion 450 extends an inclined direction at an angle 455 of about 5° to about 35°, preferably about 10° to about 20°, and in some embodiments about 15.5°. When the rack portion 150, 350, or 450 extends at an incline as described, the poultry item may be biased to slide toward the elevation members 130, 330, or 430 during the cooking process rather than being biased to slide off the free end of the rack portion 150, 350, or 450.

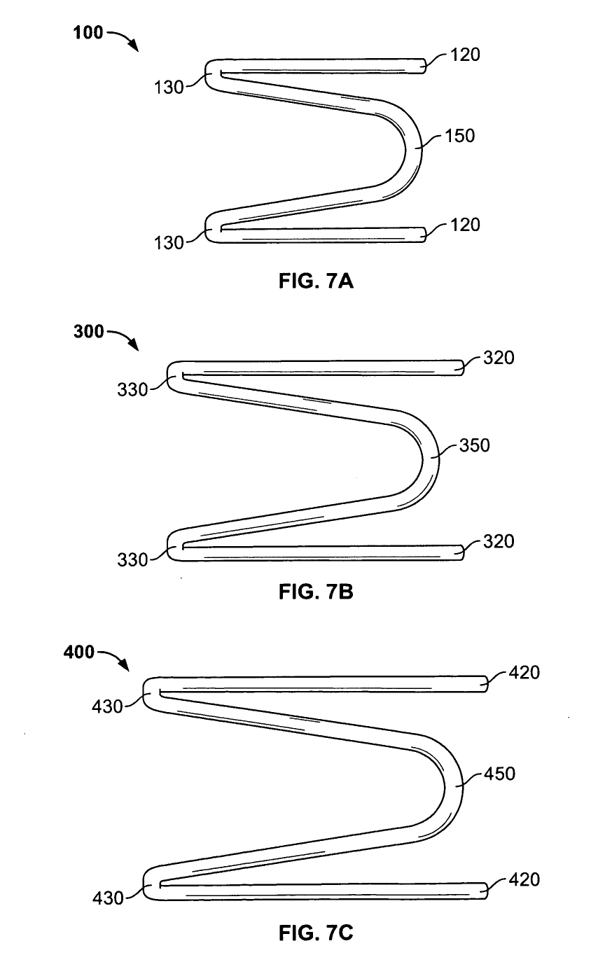

Referring now to FIGS. 7A-C, the relative configurations of the rack portions 150, 350, and 450 are shown in more detail. In the embodiment shown in FIG. 7A, the rack portion 150 of the cooking device 100 is configured to be inserted into an interior cavity of a chicken that has been prepared for roasting. In the embodiment shown in FIG. 7B, the rack portion 350 of the cooking device 300 is configured to be inserted into an interior cavity of a duck that has been prepared for roasting. The rack portion 350 (FIG. 7B) as a different configuration than the rack portion 150 (FIG. 7A) because the interior cavity of a duck may be larger than that of a chicken. Accordingly, the rack portion 350 may extend for a greater length than the rack portion 150. In the embodiment shown in FIG. 7C, the rack portion 450 of the cooking device 400 is configured to be inserted into an interior cavity of a turkey that has been prepared for roasting. The rack portion 450 (FIG. 7C) as a different configuration than the rack portions 150 and 350 (FIGS. 7A-B) because the interior cavity of a turkey may be larger than that of a duck or a chicken. Accordingly the rack portion 450 may extend for a greater length than the rack portions 350 and 150.

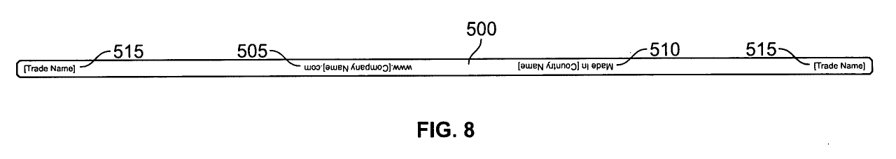

Referring now to FIG. 8, the cooking devices 100, 300, and 400 may be manufactured using a mechanical press operation or a molding operation. For example, the cooking device may comprise a moldable polymer material that is capable of substantially maintaining its rigidity in an oven cooking environment. In such circumstances, the device may be formed using an injection molding operation. In another example, the device may comprise a metallic material that is formed using a press operation or a casting operation.

In this embodiment, the cooking device may be formed from a shaft 500 of metallic material that is bent in a mechanical press operation so as to form the base members, the elevation members, and the rack portions described herein. For example, the shaft 500 may comprise a stainless steel material that is food-safe and dishwasher-safe. As shown in FIG. 8, one or more indicia may be inscribed on the metallic shaft 500 before the mechanical press operation bends the shaft into the desired configuration. The indicia may be an identity indicia 505, a country of origin indicia 510, a trade name indicia 515, or the like. In this embodiments, the indicia 505, 510, and 515 are formed using a laser-inscription process.

The metallic shaft 500 may be substantially rigid structure that can be either solid or hollow (having a lumen extending therethrough). The outer diameter of the shaft 500 may vary from about 3/16-inches to about ¾-inches, depending upon the configuration to the final cooking device, the type of food product that will be supported, and the estimated frequency of use. In some embodiments, the cooking device may be manufactured from a solid metallic shaft 500 having a cross-sectional diameter of approximately ¼-inches (approximately 6 mm). In other embodiments, the cooking device may be manufactured from a solid metallic shaft 500 having a cross-sectional diameter of approximately 5/16-inches (approximately 8 mm). In other embodiments that require more frequent usage or that may support larger food products, the cooking device may be manufactured from a solid metallic shaft 500 having a cross-sectional diameter of approximately ⅜-inches or greater (approximately 8 mm or greater).

The length of the shaft 500 may vary, depending upon the configuration to the final cooking device, the type of food product that will be supported, and other factors. For example, the length of the shaft 500 before the mechanical press operation may be about 28-inches (711 mm) for some embodiments that are configured to engage a chicken during the cooking process. In another example, the length of the shaft 500 before the mechanical press operation may be about 32-inches (7812 mm) for some embodiments that are configured to engage a duck during the cooking process. In a further example, the length of the shaft 500 before the mechanical press operation may be about 36-inches (914 mm) for some embodiments that are configured to engage a turkey during the cooking process.

After the appropriately sized shaft 500 is optionally inscribed with the indicia 505, 510, or 510, the shaft 500 may be cleaned and polished to remove some surface imperfections. Then, the shaft may be bent to the desired configuration using a mechanical press operation (either a manual press or an automated machine). After the press operation, the formed part may be disposed in a cleansing bath and subsequently dried.

In operation, the cooking devices 100, 300, and 400 may be used in cooking processes to maintain the poultry item in an elevated position such that the breast portion faces generally downward. For example, the breast portion of the poultry item may face generally downward toward a cooking surface such as a roasting pan, a cooking tray, a casserole dish, a barbecue rack, or the like. In some embodiments, the cooking device 100 (refer to FIGS. 1-2) may be used to engage a poultry item 200 (e.g., chicken) during a roasting process. In such circumstances, the chicken may be approximately 3 to 7 pounds and may be washed under cold water before being engage with the rack portion 150 of the cooking device 100. The rack portion 150 may engage an interior portion of the chicken such that the chicken is arranged with the breast portion 205 facing generally downward toward the base members 120. The cooking device 100 (with the chicken retained thereon) may then be placed on a roasting pan, casserole dish, or other cooking surface so that the chicken is elevated above that cooking surface. Optionally, a marinade or other liquid may be added into the cavity 250 of the chicken to add flavor to the meat as it is cooked. The roasting pan, casserole dish, or other cooking surface on which the cooking device 100 rests may be placed into an oven that has been preheated to a temperature of about 350°. The chicken that is engaged with the cooking device 100 may be roasted in the oven for approximately 15 minutes per pound of chicken or until the chicken is thoroughly cooked. Then, the cooking device 100 and chicken may be removed from the oven and may cool in ambient air for approximately 10 minutes, at which time he chicken may be carved and consumed.

In those circumstances, basting may not be required during the oven roasting process because the juices in the internal cavity 250 of the chicken may remain in the cavity and penetrate into the breast portions 205. As previously described, a marinade or liquid such as wine may be poured into the internal cavity before the oven roasting process. Such an implementation allows for an internal self-basting action that occurs during the roasting process. For example, the marinade or liquid could be water, wine, flavored marinade liquids, fruits such as quartered oranges or lemons, or a combination thereof so as to add flavor as well as increase the moisture content. Also, spices and other solid flavoring additives could be introduced into the internal cavity so as to penetrate into the breast portions of the poultry item.

It should be understood that the device may be used according to the aforementioned process in order to cook poultry items other than chicken. For example, the cooking process may be used to roast a duck, turkey, or the like.

It should also be understood that the cooking device may also be used in a barbecue grill rather than a conventional oven. In such embodiments, the base members (e.g., members 120 depicted in FIGS. 1-2) may rest upon the substantially horizontal barbecue rack that is disposed in the barbecue grill. Again, because the juices in the internal cavity of the chicken may remain in the cavity and penetrate into the breast portions, the cooking device 100, 300, or 400 may permit a poultry item having a desirably moist breast portion to be roasted in a barbecue grill.

It should be understood that the cooking devices 100, 300, and 400 are not limited to the embodiments illustrated in FIGS. 1-7. For example, the base members 120, 320, and 420 may comprise substantially planar discs or footings that are configured to rest on a substantially horizontal cooking surface. Alternatively, a base member may comprise a shaft portion that is curved to form an arcuate or circular base, which is capable of resting on a substantially horizontal cooking surface.

In other embodiments, the rack portion 150, 350, or 450 may have various shapes and configurations that are adapted to engage and interior portion of a poultry item 200 or other food product. For example, the rack portion 150, 350, or 450 may include only one substantially planar tongue member that extends from the elevation members 130, 330, or 430. In another example, the rack portion may comprise two, three, four, five, six, or more extension fingers that extend from the elevation members 130, 330, or 430 and are configured to extend into the cavity and to engage an interior portion of the poultry item.

A number of embodiments of the invention have been described. Nevertheless, it will be understood that various modifications may be made without departing from the spirit and scope of the invention. Accordingly, other embodiments are within the scope of the following claims.

What is claimed is:

1. A device, comprising:
at least one base member to rest upon a substantially horizontal cooking surface; and
a rack to retain a poultry item, the rack being coupled to the base member and having at least one upper support member to engage an internal portion of the poultry item, at least a portion of the upper support member being inclined relative to the substantially horizontal cooking surface when the base member rests upon the cooking surface,
wherein when the rack retains the poultry item, the rack is operable to maintain the poultry item in an elevated position above the cooking surface such that a breast portion of the poultry item faces substantially downward.

2. The device of claim 1, wherein the base member comprises a shaft portion having a bottom surface to engage the cooking surface.

3. The device of claim 1, further comprising a second base member to rest upon the cooking surface, the second base member being spaced apart from the first base member and being coupled to the rack.

4. The device of claim 1, wherein the upper support member extends in an inclined direction at an angle of less than about 35° relative to the substantially horizontal cooking surface.

5. The device of claim 4, wherein the upper support member extends in an inclined direction at an angle of about 10° to about 20° relative to the substantially horizontal cooking surface.

6. The device of claim 1, wherein the rack comprises a metallic shaft having an outer cross-sectional diameter of about ¼-inch.

7. The device of claim 1, wherein the rack comprises a metallic shaft having a outer cross-sectional diameter of about ⅜-inch.

8. The device of claim 1, wherein the base member is adapted to rest upon the substantially horizontal cooking surface selected from the group consisting of: a roasting pan, a cooking tray, a casserole dish, and a barbeque rack.

9. The device of claim 1, wherein the rack is configured to retain the poultry item selected from the group consisting of: a chicken, a duck, and a turkey.

10. A device for cooking a poultry item, comprising:
a base means for resting upon a substantially horizontal cooking surface; and
a means for retaining a poultry item in an elevated position above the cooking surface such that a breast portion of the poultry item faces substantially downward toward the cooking surface, the retaining means being coupled to the base means and being operable to extend into an internal cavity of the poultry item.

11. The device of claim 10, wherein the base means comprises a first elongate base member and a second elongate base member to rest upon the cooking surface, the second base member being spaced apart from the first base member.

12. The device of claim 10, wherein the retaining means comprises an upper support member that is inclined relative to the substantially horizontal cooking surface when the base member rests upon the cooking surface.

13. The device of claim 12, wherein the upper support member extends in an inclined direction at an angle of about 10° to about 20° relative to the substantially horizontal cooking surface.

14. The device of claim 10, wherein the retaining means comprises a metallic shaft having an outer cross-sectional diameter of at least about ¼-inch.

15. The device of claim 10, wherein the base means is adapted to rest upon the substantially horizontal cooking surface selected from the group consisting of: a roasting pan, a cooking tray, a casserole dish, and a barbeque rack.

16. The device of claim 10, wherein the retaining means is configured to retain the poultry item selected from the group consisting of: a chicken, a duck, and a turkey.

17. A method of cooking a poultry item, comprising:
inserting at least a portion of a cooking rack device inside an internal cavity of a poultry item;
arranging at least a portion of the cooking rack device on a substantially horizontal cooking surface such that the cooking rack device supports the poultry item in an elevated position above the cooking surface; and
heating the poultry item for a period of time while a breast portion of the poultry item continuously faces substantially downward toward the cooking surface.

18. The method of claim 17, further comprising inserting a liquid in the internal cavity of the poultry item so that at least a portion of the liquid is retained in the internal cavity.

19. The method of claim 17, wherein juices in the internal cavity at least partially penetrate into the breast portion of the poultry item when the poultry item is heated.

20. The method of claim 17, wherein the poultry item is in the elevated position above the cooking surface such that the poultry item's exterior is heated without direct-contact heating between the cooking surface and the poultry item's exterior.
